(19) United States
(12) Patent Application Publication
(10) Pub. No.: US 2012/0169828 A1
(43) Pub. Date: Jul. 5, 2012

(54) VIDEO TELEPHONY METHOD AND APPARATUS OF MOBILE TERMINAL

(75) Inventor: Joon Jae LEE, Seoul (KR)

(73) Assignee: SAMSUNG ELECTRONICS CO. LTD., Suwon-si (KR)

(21) Appl. No.: 13/337,537

(22) Filed: Dec. 27, 2011

(30) Foreign Application Priority Data
Jan. 3, 2011 (KR) 10-2011-0000110

(51) Int. Cl. H04N 7/14

(52) U.S. Cl. 348/14.02; 348/E07.078

(57) ABSTRACT

A method for enhancing video quality in the video telephony and a mobile terminal for supporting the video telephony method are provided. The video telephony method includes establishing a video telephony session with a counterpart terminal, receiving video transmitted by the counterpart terminal, identifying characteristic of the video data, generating a video quality change command according to the characteristic, and transmitting the video quality change command to the counterpart terminal.

### PRIORITY

This application claims the benefit under 35 U.S.C. §119(a) of a Korean patent application filed on Jan. 3, 2011 in the Korean Intellectual Property Office and assigned Serial No. 10-2011-0000110, the entire disclosure of which is hereby incorporated by reference.

### BACKGROUND OF THE INVENTION

1. Field of the Invention

The present invention relates to a video telephony method and apparatus of a mobile terminal. More particularly, the present invention relates to a method for enhancing video quality in video telephony and a mobile terminal for supporting the video telephony method.

2. Description of the Related Art

With the advance of digital technology, various types of mobile terminals such as a mobile communication terminal, a Personal Digital Assistant (PDA), an electronic dictionary, a Smartphone, and a tablet Personal Computer (PC) are emerging with mobile communication and personal information processing capabilities. Such mobile terminals are configured to support various supplementary functions such as short messaging service, video telephony, electronic dictionary, Internet access, etc. as well as a basic voice communication function. Recently, the digital camera function is one of the basic supplementary functions. The mobile terminal equipped with a camera module is capable of capturing a motion or still picture and transferring the captured picture to another user. More particularly, the video telephony functionality based on the digital camera module is becoming an attractive service.

Video telephony on the current 3^{rd} Generation (3G) network is serviced in compliance with the 3G-324M protocol, which is the International Standard, and the typical data rate of the video telephony supported in the 3G network is 64 kbps although the maximum audio, video, and data amounts recommended in the standard vary depending on the data transmission device. That is, the conventional video telephony is capable of transmitting the video and audio adjusted in bit rate within 64 kbs as the maximum bandwidth of the 3G networks. Typically the bandwidth is occupied by video in the range of 48-50 kbps, audio in the range of 4-12 kbps, and data of 2 kbps.

The conventional mobile terminal supporting video telephony is configured to request the counterpart terminal to enhance the received video quality according to the user settings. For example, when the video quality of the video telephony is low, the terminal user can request the counterpart terminal to enhance the video quality in a complex manipulation process by calling the terminal menu, navigating menu items for the target function, selecting a target menu (e.g., video quality enhancement menu), and selecting a sub-menu item in the target menu (e.g., target frame rate).

In view of the user, however, it is very inconvenient to perform such a complex manipulation to enhance the video quality during execution of the video telephony function. Furthermore, many users are not aware of the video quality enhancement function of ongoing video telephony. In most cases, the users are likely to assume that the video quality degradation during the ongoing video telephony is caused by abnormal operations of the terminal or network. Since the conventional video telephony service is configured such that the user determines the frame rate of the mobile terminal, the video telephony service can be provided with poor video quality if an inappropriate setting of the frame rate is selected and lack of the awareness of the video quality enhancement function.

### SUMMARY OF THE INVENTION

Aspects of the present invention are to address at least the above-mentioned problems and/or disadvantages and to provide at least the advantages described below. Accordingly, an aspect of the present invention is to provide a method for enhancing video quality of an ongoing video telephony call and a mobile terminal supporting the video quality enhancement method.

Another aspect of the present invention is to provide a method for enhancing video quality of an ongoing video telephony call and a mobile terminal supporting the video quality enhancement method that is capable of requesting the video quality of the counterpart terminal in adaptation to the characteristic of the received video.

Another aspect of the present invention is to provide a method for enhancing video quality of an ongoing video telephony call and a mobile terminal supporting the video quality enhancement method that is capable of configuring the video quality change command requesting the counterpart terminal to change video frame rate in adaptation to the characteristic of the received video and transmits the video quality change command to the counterpart terminal.

Furthermore, it is another aspect of the present invention is to provide a method for enhancing video quality of an ongoing video telephony call and a mobile terminal supporting the video quality enhancement method that is capable of enhancing video quality of the video telephony service by implementing an optimized environment for improving the received video quality at both sides of the video telephony call.

In accordance with an aspect of the present invention, a video telephony method of a mobile terminal is provided. The method includes establishing a video telephony session with a counterpart terminal, receiving video transmitted by the counterpart terminal, identifying a characteristic of the video data, generating a video quality change command according to the characteristic, and transmitting the video quality change command to the counterpart terminal.

In accordance with an aspect of the present invention, a computer-readable storage medium comprises programs for a process to execute the above described method.

In accordance with another aspect of the present invention, a mobile terminal is provided. The terminal includes a camera module for capturing video of an object in a video telephony session, a display unit for displaying the video received from the camera module and video received from a counterpart terminal in the video telephony session, a storage unit for storing threshold values for analyzing a characteristic of the video received from the counterpart terminal, and a control unit for identifying the characteristic of the video data, for generating a video quality change command according to the characteristic, and for transmitting the video quality change command to the counterpart terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a signaling diagram illustrating operations of mobile terminals communicating in a video telephony call according to an exemplary embodiment of the present invention;

FIG. 2 is a block diagram illustrating a configuration of a mobile terminal according to an exemplary embodiment of the present invention;

FIG. 3 is a flowchart illustrating a method for a video telephony method of a mobile terminal according to an exemplary embodiment of the prevent invention; and

FIG. 4 is a flowchart illustrating a procedure for configuring a video quality change command according to a characteristic of a received video image in a mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention propose a method for providing a video telephony service of enhanced video quality and a mobile terminal for supporting the enhanced quality video telephony service. According to an exemplary embodiment of the present invention, a mobile terminal can analyze the characteristic of the video received in the ongoing video telephony call and configure the video quality change command based on the analysis result. The video quality change command is transmitted to the counterpart terminal, and the counterpart terminal transmits video at the frame rate indicated by the video quality change command. In this manner, the present invention is capable of providing the video telephony service with enhanced video quality.

In the following description, the video quality change command is a command requesting the counterpart terminal to change the transmission frame rate and is represented by “video Temporal-Spatial Tradeoff command.”

Descriptions are made of the configuration of a mobile terminal and a method for controlling the mobile terminal according to exemplary embodiments of the present invention hereinafter with reference to the accompanying drawings. However, the configuration of the mobile terminal and the method for controlling the mobile terminal are not limited to the following description but can be practiced with modifications and changes in other exemplary embodiments.

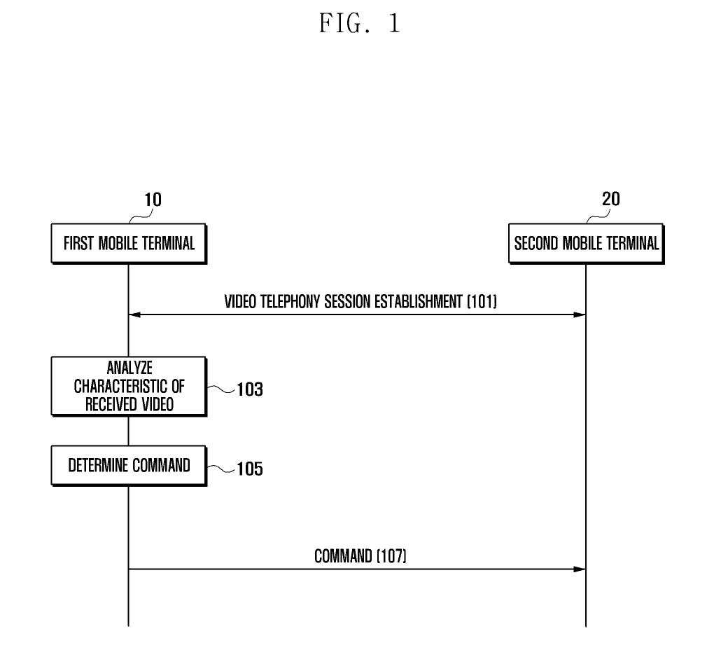

FIG. 1 is a signaling diagram illustrating operations of mobile terminals communicating in a video telephony call according to an exemplary embodiment of the present invention.

Referring to FIG. 1, the video telephony system includes a first mobile terminal 10 and a second mobile terminal 20. Although not depicted in FIG. 1, the system can includes a network such as a 3^{rd} Generation (3G) communication network for supporting video telephony service between the first and second mobile terminals 10 and 20.

The first and second mobile terminals 10 and 20 camp on the network of a specific service provider and can use the communication service, when necessary, over the network. The description is made under the assumption that the first mobile terminal 10 is a calling terminal requesting the video telephony call and the second mobile terminal 20 is a called terminal receiving the video telephony call.

The first mobile terminal 10 can transmit a video telephony call request message to the second mobile terminal 20 which is attached to the same network or a network of another service provider. The network can deliver the video telephony call request message transmitted by the first mobile terminal 10 to the second mobile terminal 20. The second mobile terminal 20 receives the video telephony call request message transmitted by the first mobile terminal 10 and transmits a video telephony call accept message to the first mobile terminal 10 via the network under the control of the user.

Through such process, the first and second mobile terminals 10 and 20 can exchange signaling messages according to a data communication protocol of the network to negotiate the rule necessary for the video telephony call and establish the video telephony call in step 101.

The first mobile terminal 10 can analyze the characteristic of the video received from the second mobile terminal 20 in the ongoing video telephony call session in step 103. In an exemplary implementation, the characteristic analysis on the received video includes determining whether the received video image is a still image having no moving object or a motion image having many moving objects. In an exemplary implementation, whether the received video image is a still image or a motion image can be determined depending on a motion vector of the received video image. Exemplary methods of discriminating between the still and motion images are explained later in the description of the operation of the mobile terminal and method for controlling the mobile terminal.

The first mobile terminal 10 can configure a video quality change command according to the characteristic of the analyzed image in step 105. In an exemplary implementation, the video quality change command is the command which requests the counterpart mobile terminal (i.e., the second mobile terminal 20) to change the frame rate of its video transmission and can be represented by “video Temporal-Spatial Tradeoff command.” An exemplary method for configuring the video quality change command in adaptation to the characteristic of the received video image is explained in the description on the operation of the mobile terminal and method for controlling the mobile terminal.

The first mobile terminal 10 transmits the configured video quality change command to the second mobile terminal 20 in step 107. Upon receipt of the video quality change command, the second mobile terminal 20 changes the frame rate of the video transmission as indicated by the video quality change command so as to provide a video image of enhanced video quality.

The description is directed to the case where the first mobile terminal 10 analyzes the characteristic of the received video and configures the video quality change command based on the analysis with reference to FIG. 1 for the simplicity of explanation. However, according to an exemplary embodiment of the present invention, both the first and second mobile terminals 10 and 20 can perform the video analysis and video quality change command configuration. That is, each of the first and second mobile terminals 10 and 20 analyzes the video received from its counterpart terminal and transmits the video quality change command configured based on the analysis result to the counterpart terminal. In this manner, the first and second mobile terminals 10 and 20 can support the video telephony service with enhanced video quality.

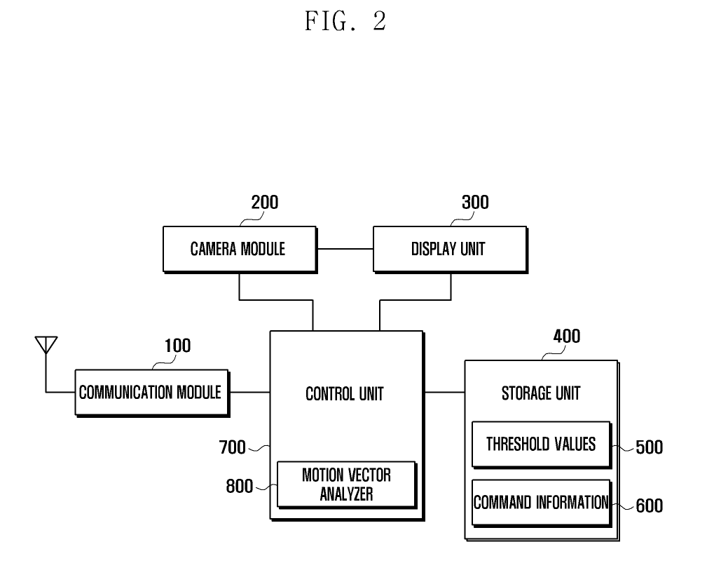

FIG. 2 is a block diagram illustrating a configuration of a mobile terminal according to an exemplary embodiment of the present invention.

Referring to FIG. 2, the mobile terminal includes a communication module 100, a camera module 200, a display unit 300, a storage unit 400, and a control unit 700. The mobile terminal can further include an audio processing unit having a microphone and a speaker, a digital broadcast module for receiving and playing a broadcast signal (e.g., Digital Multimedia Broadcasting (DMB) and Digital Video Broadcasting (DVB)), a Bluetooth module for supporting Bluetooth communication, and an Internet access module for supporting Internet access, a touchpad for supporting touch-based input, and a battery for supplying power to the internal function blocks, although not depicted in drawing.

The above structured mobile terminal activates the camera module 200 to capture a video image in response to the video telephony call activation signal input made by means of an input unit or a touch screen and transmits a video telephony call request message to the counterpart terminal by means of the communication module 100. The mobile terminal can configure a video quality change command requesting a change of frame rate of the video transmission in adaptation to a characteristic of the video received from the counterpart mobile terminal and transmit the video quality change command to the counterpart mobile terminal in the middle of the ongoing video telephony call session. If the video quality change command is received in the middle of the video telephony call session with the counterpart mobile terminal, the mobile terminal changes the frame rate of the video data transmitted to the counterpart mobile terminal as indicated by the video quality change command. In this manner, the video telephony method according to an exemplary embodiment of the present invention is capable of improving the video quality of the video telephony call service provided between the mobile terminals.

The communication module 100 is a module for supporting the communication services such as mobile communication service based on the cellular communication protocol and Internet access service (e.g., Wi-Fi service) based on a Wireless Local Area Network (WLAN). The communication module 100 can establish a communication channel with a network and process the signals transmitted and received on the communication channel. More particularly, in an exemplary embodiment of the present invention, the communication module 100 can process various types of data communicated in association with the video telephony call service. For example, the communication module 100 can transmit the video image captured by the camera module 200, receive the video data transmitted by the counterpart mobile terminal, and transmit and receive a video telephony call request message, a video telephony call accept message, and a video quality change command.

The camera module 200 is responsible for capturing still and motion pictures. More particularly in an exemplary embodiment of the present invention, the camera module 200 can capture the video image of a specific object (e.g., user) in the video telephony call service session. The camera module 200 takes an image of the object through a lens and includes a camera sensor (not shown) for converting the optical signal of the captured image to an electric signal (analog signal) and a signal processing unit for converting the analog signal received from the camera sensor to a digital signal. Here, the camera sensor can be implemented with a Charge Coupled Device (CCD) sensor, and the signal processing unit can be implemented with a Digital Signal Processor (DSP), but without limitation thereto.

The camera module 200 transfers the captured video image to the control unit 700. The camera module 200 also can transfer the captured video image to the display unit 300 in the form of a preview image.

The display unit 200 displays the operation state and data related to the operation of the mobile terminal. For example, the display unit 300 can display a home screen of the mobile terminal and execution screens of the applications running on the mobile terminal such as a messaging function, an email function, an Internet access function, a search function, a communication function, an electronic book (e-book) function, a still/motion picture capturing function, a still/motion picture play function, a mobile broadcast playback function, an audio playback function, a game function, etc. More particularly in an exemplary embodiment of the present invention, the displaying unit 300 is capable of display the video image captured by the camera module 200 along with the video image received from the counterpart terminal.

Typically, the display unit 300 is implemented with a Liquid Crystal Display (LCD) but also can be implemented with one of a Light Emitting Diode (LED), an Organic LED (OLED), and an Active Matrix OLED (AMOLED). When displaying the execution screen of an application (e.g., video images of the users at both ends), the display unit 300 can provide the screen in one of a landscape mode and a portrait mode according to the posture of the mobile terminal. In an exemplary embodiment of the present invention, the display unit 300 can be equipped with a touchscreen for supporting touch-based user input. For example, the touchscreen-enabled display unit 300 supports touch-based interactive user input to generate an input signal to the control unit 700 in response to the user input.

The storage unit 400 stores various programs and data executed and processed in the mobile terminal and can be implemented with at least one of volatile and non-volatile memories. In an exemplary implementation, the non-volatile memory can be any of a Read Only Memory (ROM) and a flash memory, and the volatile memory can be a Random Access Memory (RAM). The storage unit 400 can store the operating system, programs and data related to the display control operation of the display unit 300, programs and data related to the input control operation of the display unit 300, and the programs and data related to the video telephony function control operation of the mobile terminal, temporarily or permanently.

According to an exemplary embodiment of the present invention, the storage unit 400 can store threshold values 500 for supporting the video telephony service with enhanced video quality. The threshold values 500 include a minimum reference value or a maximum reference value for analyzing a characteristic of the video received from the counterpart terminal in the ongoing video telephony call session. In an exemplary embodiment of the present invention, the threshold values 500 can include a low threshold (Low_Threshold: LT) and a high threshold (High_Threshold: HT). The storage unit 400 can also store command information 600 determined according to the characteristic of the video received from the counterpart terminal. The command information 600 can indicate a property such as quality-preferred, balanced, and speed-preferred. The command information is explained in more detail with reference to the description of the control unit.

The control unit 700 controls overall operations of the mobile terminal. More particularly, the control unit 700 can control the operations related to the video telephony call function according to an exemplary embodiment of the present invention. For example, the control unit 700 can analyze the characteristic of the video image received from the counterpart terminal by means of the communication module 100. The control unit 700 can control to generate the video quality change command requesting the counterpart terminal to change the video data rate according to the analysis result of the characteristic of the received video and transmit the video quality change command to the counterpart terminal by means of the communication module 100. For example, when the received video is analyzed as a still image, the control unit 700 generates the video quality change command instructing to increase the data rate (i.e., decrease frame rate) in quality-preferred mode and transmits the video quality change command to the counterpart terminal. When the received video is analyzed as a motion image, the control unit 700 generates the video quality change command instructing to decrease the data rate (i.e., increase frame rate) in speed-preferred mode and transmit the video quality change command to the counterpart terminal.

Here, the control unit 700 can determine the characteristic of the received video image, i.e. discriminate between the still image and the motion image, base on the Motion Vector (MV) of the received video image. For example, the received video image is recovered in units of Macro Blocks (MBs) (e.g., 8×8, 16×16, or 32×32). More particularly, the current block is recovered by combining a previously processed frame and the residual data of the current frame using the information on the original image of the previously processed frame and the residual data of the current frame and the position of the residual data in the previous frame (i.e., motion vector), and thus the entire frame is recovered by repeating the above process.

In an exemplary embodiment of the present invention, the control unit 700 can include a motion vector analyzer 800 for analyzing the characteristic of the received video image.

The motion vector analyzer 800 determines a value obtained by summing the absolute values of the motion vectors collected during a predetermined period for the received video image. Here, the motion vector indicates the position (i.e., coordinates) matching most closely with the current block in the previous frame. The motion vector has a characteristic in that its value decreases as the relationship between the current frame and the previous and following frames increases. For example, two consecutive frames of a motion image have the characteristic in that some parts change without a change of the background (very highly correlated). Accordingly, the motion vector analyzer 800 can determine a value obtained by summing the absolute values of the total motion vector corresponding to the MB of each frame during a predetermined period using such characteristic.

Here, the motion vector analyzer 800 analyzes how the MB having a predetermined size (e.g., 8×8, 16×16, and 32×32) moves in the next frame (e.g., compared the values) to estimate the motion vector of the received video image. The conventional video processing technique searches a predetermined area around the corresponding block of the previous frame for a similar block in units of 16×16 or 8×8 MB of the current frame. There are various methods for detecting similarity between MBs, and typically if the Sum of Absolute Differences (SAD) as the absolute difference average of all the coefficients is in a predetermined range, it is determined that the corresponding block is similar. If the determined SAD is greater than a predetermined threshold, it is determined that there is no similar block.

The control unit 700 can configure the video quality change command using the value determined by the motion vector analyzer 800 and the predetermined threshold values 500. For example, when the determined value is less than the low threshold value of the threshold 500, the control unit 700 extracts the corresponding command information 600 (e.g., quality-preferred) and generates the video quality change command having the command value indicating the quality-preferred transmission (e.g., command=0) based on the extracted command information. When the determined value is in the range between the low threshold value (LT) and the high threshold value (HT), the control unit 700 extracts the corresponding command information 600 (e.g., balanced) and generates the video quality change command having the command value indicating the balanced transmission (e.g., command=1) based on the extracted command information. Likewise, when the determined value is greater than the high threshold value (HT), the control unit 700 extracts the corresponding command information 600 (e.g., speed-preferred) and generates the video quality change command having the command value indicating the speed-preferred transmission (e.g., command=2) based on the extracted command information.

The control operation of the control unit 700 is explained in more detail below with reference to the description regarding exemplary operations of the mobile terminal.

In addition, the control unit 700 can control the operations related to the generation functions of the mobile terminal. For example, the control unit 700 can control the execution and data display of a specific application. The control unit 700 also can control the receipt of the signal input through a touch-based input interface and execution of the input signal. The control unit 700 also can control the transmission/reception of various data over wired and wireless channels.

The configuration depicted in FIG. 2 can be applied to any type of device including a bar type, a folder type, a slide type, a swing type, a flip type, etc. The mobile terminal, according to an exemplary embodiment of the present invention, can be any type of information communication device and multimedia device and their equivalents supporting a video telephony function. For example, the mobile terminal can be any of a mobile communication terminal, a tablet Personal Computer (PC), and a smartphone that operates based on the communication protocols adopted by the corresponding communication systems.

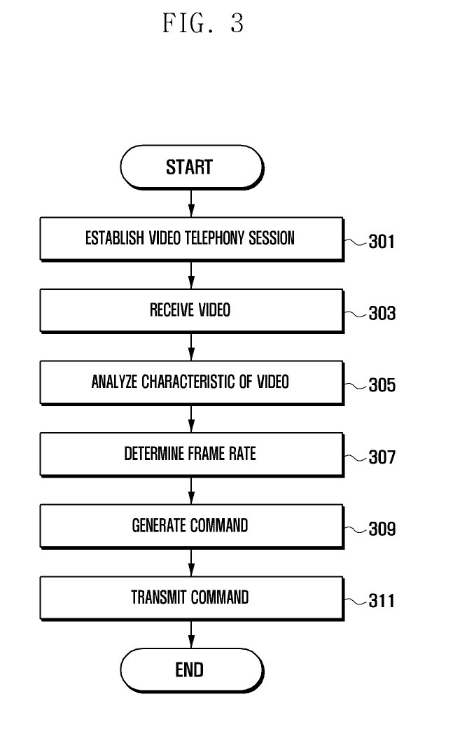

FIG. 3 is a flow-chart illustrating a method for a video telephony method of a mobile terminal according to an exemplary embodiment of the prevent invention.

Referring to FIG. 3, the control unit 700 establishes a video telephony call with a counterpart mobile terminal in step 301 and receives video from the counterpart mobile terminal in step 303. At this time, although not depicted in FIG. 3, the control unit 700 controls the display unit 300 to display the video image captured by the camera module 200 and the video image received from the counterpart mobile terminal simultaneously.

The control unit 700 analyzes a characteristic of the received video in step 305. That is, the control unit 700 analyzes to determine whether the received video image is a still image or a motion image. Here, the control unit 700 can perform the motion vector analysis on the received video image by means of the motion vector analyzer 800 and determine whether the received video image is a still image or a motion image based on the analysis result.

The control unit 700 determines the frame rate at which the counterpart mobile terminal is requested to transmit video data in step 307. That is, the control unit 700 determines the command value for the video quality change command to be transmitted to the counterpart terminal. For example, if the received video image has the characteristic of the still image, the control unit 700 sets the command to a value indicating “quality-preferred” (e.g., command=0) and, otherwise if the received video image as the characteristic of the motion image, the control unit 700 sets the command to a value indicating “speed-preferred” (e.g., command=2). Meanwhile, if the received video image has the characteristic of the still and motion images, the control unit 700 sets the command to a value indicating “balanced” (e.g., command=1).

The control unit 700 generates the video quality change command including the determined frame rate (i.e., the command value) in step 309 and transmits the generated video quality change command to the counterpart mobile terminal in step 311. If the video quality change command is received, the counterpart mobile terminal can transmit the video data at the frame rate indicated by the command value in the video quality change command, the frame rate corresponding to one of “quality-preferred,” “balanced,” and “speed-preferred.”

When the video quality change command is received, the counterpart mobile terminal adjusts the frame rate of the video image captured by its camera module 200 and transmits the video image at the corrected frame rate. Accordingly, the mobile terminal can receive the video data at the frame rate requested to the counterpart terminal so as to display the received video on the display unit 300 in adjusted quality. In exemplary embodiments of the present invention, the video quality enhancement signaling is performed automatically between the mobile terminals involved in the ongoing video telephony session so as to provide the users with the improved video telephony service without cumbersome user actions.

According to an exemplary embodiment of the present invention, the mobile terminal can analyze the characteristic of the video data received from the counterpart terminal and generate the video quality change command to the counterpart terminal based on the analysis result, as described above.

There is a tradeoff relationship between the frame rate of the video transmission and the video quality per frame in the given video telephony bandwidth. Accordingly, it is preferred to set the frame rate of the video transmission to an appropriate value in order to provide the service with enhanced video quality. Assuming the given video telephony service bandwidth of 48 Kbps, as the frame rate increases, the data amount per frame decreases, resulting in degradation of video quality, and in contrast, as the frame rate decreases, the data amount per frame increases, resulting in improvement of video quality.

According to an exemplary embodiment of the present invention, if the received video image has the characteristic of the still image, the mobile terminal configures the video quality change command to decrease the frame rate in order for the counterpart terminal to transmit the video data in quality-preferred mode. Otherwise if the received video image has the characteristic of the motion image, the mobile terminal configures the video quality change command to increase the frame rate in order for the counterpart terminal to transmit the video data in speed-preferred mode.

According to an exemplary embodiment of the present invention, whether the received video has the characteristic of the still image or the motion image is determined based on the Motion Vector (MV) of the received video data. The value of the motion vector decreases as the relationship between the current frame and the previous and next frames increases and increases as the relationship decreases.

According to an exemplary embodiment of the present invention, it is possible to determine the absolute value of the total motion vectors corresponding to the individual MBs of the video data received during a predetermined period using such a characteristic.

In case that the determined value is less than the predefined low threshold values 500, the mobile terminal configures the video quality change command with a value indicating “quality-preferred” (e.g., command=0) and transmits the video quality change command to the counterpart mobile terminal to request a change of the frame rate of the video transmission (adjustment of the frame rate for the quality-preferred transmission mode). In case that the determined value is greater than the predefined high threshold values 500, the mobile terminal configures the video quality change command with a value indicating “speed-preferred” (e.g., command=2) and transmit the video quality change command to the counterpart mobile terminal to request a change of the frame rate of the video transmission (adjustment of the frame rate for the speed-preferred transmission mode). Meanwhile, in case that the determined value is in the range between the predefined low and high threshold values, the mobile terminal configures the video quality change command with a value indicating “balanced” (e.g., command=1) and transmits the video quality change command to the counterpart mobile terminal to request a change of the frame rate of the video transmission (adjustment of the frame rate for the balanced transmission mode). The command values of the video quality change command can be summarized as shown in Table 1.

TABLE 1

| Calculation value of MV | Command |
|---|---|
| Sum of MV < Low_Threshold | Quality-preferred |
| Low_Threshold ≦ Sum of MV ≦ High_Threshold | Balanced |
| Sum of MV > High_Threshold | Speed-preferred |

As shown in Table 1, the motion vector analyzer 800 of the control unit 700 determines the sum of the absolute values of total motion vectors (sum of MV) corresponding to the individual MBs of the video data received during the predetermined period by characteristic analysis on the received video image. That is, the motion vector analyzer 800 can determine the sum of MV as described above. The control unit 700 can compare the analysis result, i.e., the sum of MV, with the predetermined thresholds 500. Here, the control unit 700 can determine whether the sum of MV is less than the low threshold value (LT) of the threshold 500, greater than the higher threshold value (HT), or in the range between the LT and HT.

If it is determined that the Sum of MV is less than the low threshold value (LT) (i.e., Sum of MV<Low_Threshold), the control unit 700 sets the command value to 0 (command=0) according to the corresponding command information 600 (e.g., quality-preferred). If it is determine that the Sum of MV is in the range between the low threshold value (LT) and the high threshold value (HT) (Low_Threshold≦Sum of MV≦High_Threshold), the control unit 700 set the command value to 1 (command=1) according to the corresponding command information 600 (e.g., balanced). If it is determined that the Sum of MV is greater than the high threshold value (HT) (i.e., Sum of MV>High_Threshold), the control unit 700 sets the command value to 2 (command=2) according to the corresponding command information 600 (e.g., speed-preferred).

As described above, a video telephony method according to an exemplary embodiment of the present invention is capable of analyzing the characteristic of the video data received from a counterpart terminal in the ongoing video telephony or video conference session, generating the video quality change command having the value determined in adaptation to the characteristic of the received data and transmitting the video quality change command to the counterpart terminal. The counterpart terminal can configure the frame rate as indicated by the video quality change command such that the video data are transmitted in one of the quality-preferred, balanced, and speed preferred modes. According to an exemplary embodiment of the present invention, the video quality change command is configured in adaptation to the characteristic of the received video data and sent to the counterpart terminal automatically in the middle of the video telephony (or video conference) call session so as to provide the video telephony (or video conference) service with enhanced video quality.

According to an exemplary embodiment of the present invention, the video data characteristic analysis and video quality change command transmission can be executed periodically or when a significant change is detected in the received video image (e.g., large variation of motion vector).

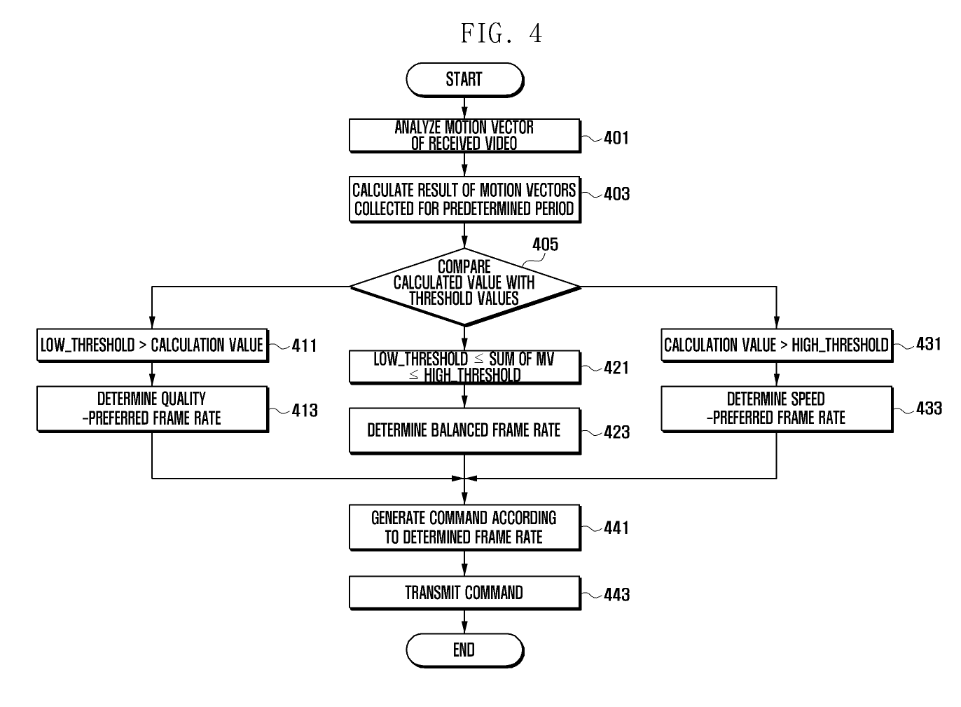

FIG. 4 is a flowchart illustrating a procedure for configuring a video quality change command according to a characteristic of a received video image in a mobile terminal according to an exemplary embodiment of the present invention.

Referring to FIG. 4, the control unit 700 analyzes the motion vector of the video received from the counterpart mobile terminal in step 401 and outputs the calculation value of the motion vectors collected during a predetermined period in step 403. As aforementioned, the calculation result is the sum of the absolute values of the mobile vectors corresponding to the MBs for a predetermined period of time.

The control unit 700 compares the calculation value obtained based on the received video with the predetermined threshold values 500 in step 405. As aforementioned, the control unit 700 determines whether the calculation value is less than the low threshold value (LT) or greater than the high threshold value (HT) or in the range between the low threshold value (LT) and the high threshold value (HT).

If it is determined that the calculation value is less than the low threshold value (LT) in step 411, the control unit 700 determines the frame rate of quality-preferred transmission mode in step 413. Once the frame rate is determined, the control unit 700 generates the video quality change command instructing to change the frame rate as indicated (e.g., the video quality change command of which command value is set to 0) in step 441 and transmits the video quality change command to the counterpart mobile terminal in step 443.

If it is determined that the calculation value is equal to or greater than the low threshold (LT) and equal to or less than the high threshold (HT) in step 421, the control unit 700 determines the frame rate of balanced transmission mode in step 423. Once the frame rate is determined, the control unit 700 generates the video quality change command instructing to change the frame rate as indicated (e.g., the video quality change command of which command value is set to 1) in step 441 and transmits the video quality change command to the counterpart mobile terminal in step 443.

If it is determined that the calculation value is greater than the high threshold value (HT) in step 431, the control unit 700 determines the frame rate of speed-preferred transmission mode in step 433. Once the frame rate is determined, the control unit 700 generates the video quality change command instructing to change the frame rate as indicated (e.g., the video quality change command of which command value is set to 2) in step 441 and transmits the video quality change command to the counterpart mobile terminal in step 443.

As described above, an exemplary video telephony method and apparatus of the mobile terminal proposed in the present invention is capable of analyzing the characteristic of the video received from the counterpart terminal and configuring the video quality change command based on the analysis result. According to an exemplary video telephony method and apparatus of the present invention, the mobile terminal generates the video quality change command to the counterpart mobile terminal automatically so as to adjust the frame rate of the video transmission as indicated by the video quality change command. In an exemplary video telephony method of the present invention, it is possible to adjust the video quality of video telephony service adaptively in real time, resulting in quality enhancement of the video telephony service.

According to an exemplary embodiment of the present invention, the mobile terminal can analyze the characteristic of the video received from the counterpart terminal and generate the video quality change command requesting the counterpart terminal to change the data rate of the video transmission in the middle of the video telephony session. Accordingly, the user can receive the video telephony service with the enhanced video quality without cumbersome user actions.

An exemplary video telephony method of the present invention can be applied to all types of mobile terminals. An exemplary video telephony method of the present invention is capable of analyzing the characteristic of the received video data and generating the video quality change command to the counterpart terminal automatically, thereby improving user convenience, and usability and competitiveness of the mobile terminal.

An exemplary video telephony method of the present invention can be recorded in computer-readable storage media in the form of program commands so as to be executed by various computer means. Here, the computer-readable storage media can store the program commands, data files, and data structures independently or in the form of their combination. The program commands recorded in the storage media can be designed and configured for dedicated use in the present invention or those well-known in the art.

The computer-readable media may include program commands, data files, data structures, etc. separately or compositely. The program commands recorded in the media may be particularly designed and configured for the present invention, or known and used by those skilled in the computer software field. The computer-readable media may be magnetic media such as a hard disk, a floppy disk and magnetic tape, optical media such as a Compact Disk Read-Only Memory (CD-ROM) and a Digital Versatile Disk (DVD), magneto-optical media such as floptical disk, and hardware devices such as a ROM, a Random-Access Memory (RAM), a flash memory, etc., particularly implemented to store and execute program commands. The program commands may be machine language codes produced by a compiler and high-level language codes that can be executed by computers using an interpreter, etc. In order to perform exemplary operations of the present invention, the hardware devices may be implemented to operate as at least one software module, and vice versa.

It will be understood by those skilled in the art that exemplary embodiments of the present invention may be practiced without changes of technical concept and inevitable features described above. Therefore, the aforementioned exemplary embodiments are merely illustrative of the invention in every aspect, and not limitative of the same. The scope of the present invention is defined by the appended claims, and is not restricted by the description herein set forth. Further, various changes and modifications to be made within the scope of the appended claims and equivalents thereof are to fall within the scope of the present invention.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A video telephony method of a mobile terminal, the method comprising:
establishing a video telephony session with a counterpart terminal;
receiving video transmitted by the counterpart terminal;
identifying a characteristic of the video data;
generating a video quality change command according to the characteristic; and
transmitting the video quality change command to the counterpart terminal.

2. The method of claim 1, wherein the identifying comprises determining whether the received video comprises a still image or a motion image based on motion vectors of the received video.

3. The method of claim 2, wherein the generating comprises:
configuring, when the received video comprises the still image, the video quality change command with a command value indicating a quality-preferred frame rate; and
configuring, when the received video comprises the motion picture, the video quality change command with a command value indicating a speed-preferred frame rate.

4. The method of claim 2, wherein the identifying comprises:
determining a sum of absolute values of the motion vectors collected in the received video for a predetermined period; and
comparing the sum with threshold values.

5. The method of claim 4, wherein the threshold values comprises a low threshold value as a minimum reference value for characteristic analysis of the received video and a high threshold value as a maximum reference value for characteristic analysis of the received video.

6. The method of claim 5, wherein the generating comprises:
configuring, when the sum of absolute values is less than the low threshold value, the video quality change command with a command value indicating a quality-preferred frame rate; and
configuring, when the sum of absolute values is greater than the high threshold value, the video quality change command with a command value indicating a speed-preferred frame rate.

7. The method of claim 5, wherein the video quality change command comprises a command value indicating a data rate at which the counterpart terminal is requested to transmit the video.

8. The method of claim 5, wherein the generating comprises:
configuring, when the sum of absolute values is less than the high threshold value and greater than the low threshold, the video quality change command with a command value indicating a balanced frame rate.

9. The method of claim 1, further comprising receiving the video with video quality enhanced according to the video quality change command.

10. A mobile terminal comprising:
a camera module for capturing video of an object in a video telephony session;
a display unit for displaying the video received from the camera module and video received from a counterpart terminal in the video telephony session;
a storage unit for storing threshold values for analyzing a characteristic of the video received from the counterpart terminal; and
a control unit for identifying the characteristic of the video data, for generating a video quality change command according to the characteristic, and for transmitting the video quality change command to the counterpart terminal.

11. The mobile terminal of claim 10, wherein the threshold values comprise a low threshold value as a minimum reference value for characteristic analysis of the received video and a high threshold value as a maximum reference value for characteristic analysis of the received video.

12. The mobile terminal of claim 11, wherein the control unit determines whether the received video comprises a still image or a motion image based on motion vectors of the received video, and configures the video quality change command with a command value indicating one of a quality-preferred frame rate and a speed-preferred frame rate.

13. The mobile terminal of claim 12, wherein the control unit comprises a motion vector analyzer for determining a sum of absolute values of motion vectors collected in the received video for a predetermined period.

14. The mobile terminal of claim 13, wherein the control unit determines whether the received video comprises the still image or the motion image according to the sum of the absolute value of the motion vectors.

15. The mobile terminal of claim 14, wherein the control unit compares the sum with a low threshold value and a high threshold value and generates the video quality change command according to the comparison result.

16. The mobile terminal of claim 15, wherein the control unit configures, when the sum of absolute values is less than the low threshold value, the video quality change command with a command value indicating a quality-preferred frame rate and configures, when the sum of absolute values is greater than the high threshold value, the video quality change command with a command value indicating a speed-preferred frame rate.

17. The mobile terminal of claim 15, wherein the control unit configures, when the sum of absolute values is less than the high threshold value and greater than the low threshold value, the video quality change command with a command value indicating a balanced frame rate.
